(19) United States
(12) Patent Application Publication
(10) Pub. No.: US 2004/0084959 A1
(43) Pub. Date: May 6, 2004

(54) Hydraulic brake apparatus for a vehicle

(75) Inventor: Akihito Kusano, Toyota city (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/693,993

(22) Filed: Oct. 28, 2003

(30) Foreign Application Priority Data
Oct. 29, 2002 (JP) 2002-314617

(51) Int. Cl. B60T 8/36

(52) U.S. Cl. 303/119.2

(57) ABSTRACT

The present invention is directed to a hydraulic brake apparatus provided with a pressure generator for generating hydraulic pressure in response to operation of a manually operated braking member, and a pressure regulating device disposed between the pressure generator and a wheel brake cylinder, and connected with a reservoir, so as to regulate the hydraulic pressure fed into the wheel brake cylinder to provide a desired pressure less than the hydraulic pressure generated by the pressure generator. The pressure regulating device includes a linear proportioning solenoid valve for selectively communicating the wheel brake cylinder with one of the reservoir and the pressure generator, to regulate a pressure difference between the pressures of the pressure generator and the wheel brake cylinder, into a desired value in response to electromagnetic force exerted by the solenoid valve, and a pressure difference limiting device for blocking the communication between the wheel brake cylinder and the reservoir, and communicating the pressure generator with the wheel brake cylinder, when the pressure difference is equal to or greater than a predetermined value.

This application claims priority under 35 U.S.C. Sec.119 to No.2002-314617 filed in Japan on Oct. 29, 2002, the entire content of which is herein incorporated by reference.

### BACKGROUND OF THE INVENTION

1. Field of the Invention

The present invention relates to a hydraulic brake apparatus for supplying hydraulic brake pressure to each wheel brake cylinder operatively mounted on each wheel of a vehicle, and more particularly to the apparatus which is provided with a pressure regulating device for regulating the hydraulic brake pressure supplied to at least a part of the wheel brake cylinders into a desired hydraulic pressure.

2. Description of the Related Arts

Heretofore, there is known a hydraulic brake apparatus for a vehicle provided with a pressure regulating device, which is adapted to regulate the hydraulic brake pressure supplied to a wheel brake cylinder into a desired hydraulic pressure, and which is adapted to reduce the hydraulic brake pressure corresponding to a regenerative braking force when used for a regenerative braking cooperative control for example, as disclosed in Japanese Patent Laid-open Publication No.10-315946, for example.

In the Publication as described above, there is disclosed a hydraulic pressure braking system for a vehicle which is characterized in including a reservoir capable of receiving brake fluid drained from a wheel cylinder through a pressure control valve device during a single braking operation, and feeding the fluid back to a pressure source after the braking operation, and characterized in that a reservoir capacity of a maximal amount of the fluid to be received in the reservoir during the single braking operation is smaller than a wheel cylinder capacity of a maximal amount of the fluid to be received in the wheel cylinder from its non-braking state to its braking state. And, it is described in the Publication that provided that the reservoir is adapted to receive the brake fluid drained from the wheel cylinder through during a single braking operation, and feed the fluid back to the pressure source after the braking operation, and that the reservoir capacity is made smaller than the wheel cylinder capacity, the vehicle can be braked without trouble, even if a failure or erroneous operation of the pressure control valve device was found to cause a flow of the brake fluid from the wheel cylinder to the reservoir without any limit. Also, it is described in the Publication that when the fluid is drained from the wheel cylinder due to the erroneous operation or the like of the pressure control valve device, the brake fluid will be remained in the wheel cylinder even if the fluid is not fed from the pressure source, because the reservoir capacity is smaller than the wheel cylinder capacity, so that a certain braking force can be obtained. Furthermore, it is described that if the brake fluid can be added by the pressure source, a braking force large enough for the brake system can be produced, with a relatively small amount of fluid added to it.

According to the system as disclosed in the above Japanese Publication No.10-315946, however, it can be so concluded that the braking operation will not start until the reservoir is fulfilled with the brake fluid, even if the reservoir capacity is made smaller than the wheel cylinder capacity. For example, when a failure or the like of the pressure control valve device occurs during the regenerative braking cooperative control, it is important to shift the braking control to the hydraulic pressure control immediately, irrespective of the amount of fluid drained into the reservoir. In the system as disclosed in the Publication, the pressure control valve device has been provided with a reservoir for reducing the pressure, whereas according to the present invention, the reservoir for reducing the pressure is not necessarily required, and a reservoir under atmospheric pressure which is generally provided for a master cylinder may be used instead of it. Therefore, the pressure control valve device as disclosed in the Publication is to be distinguished from a pressure regulating device according to the present embodiment, as will be described later.

### SUMMARY OF THE INVENTION

Accordingly, it is an object of the present invention to provide a hydraulic brake apparatus for a vehicle, which is provided with a pressure regulating device, and which is capable of ensuring a hydraulic pressure braking operation immediately, even if the pressure regulating device or the like is failed.

In order to accomplish the above and other objects, the hydraulic brake apparatus is provided with a pressure generator for generating hydraulic pressure in response to operation of a manually operated braking member, a wheel brake cylinder operatively mounted on a wheel of the vehicle for applying braking force to the wheel with the hydraulic pressure fed from the pressure generator, a reservoir for storing brake fluid, and a pressure regulating device which is disposed between the pressure generator and the wheel brake cylinder, and connected with the reservoir. The pressure regulating device is adapted to regulate the hydraulic pressure fed into the wheel brake cylinder to provide a desired pressure less than the hydraulic pressure generated by the pressure generator. And, the pressure regulating device includes a linear proportioning solenoid valve for selectively communicating the wheel brake cylinder with one of the reservoir and the pressure generator, to regulate a pressure difference between the hydraulic pressure output from the pressure generator and the hydraulic pressure fed into the wheel brake cylinder, into a desired value in response to electromagnetic force exerted by the linear proportioning solenoid valve, and a pressure difference limiting device for blocking the communication between the wheel brake cylinder and the reservoir, and communicating the pressure generator with the wheel brake cylinder, when the pressure difference between the hydraulic pressure output from the pressure generator and the hydraulic pressure fed into the wheel brake cylinder is equal to or greater than a predetermined value. The pressure generator as described above may include a tandem master cylinder.

In the hydraulic brake apparatus as described above, the linear proportioning solenoid valve preferably includes a valve member with opposite ends thereof applied with the hydraulic pressure output from the pressure generator and the hydraulic pressure fed into the wheel brake cylinder, respectively, and an electromagnetic actuator for actuating the valve member. And, the pressure difference limiting device may be disposed between the valve member and the actuator, and provided with an elastic member for holding the valve member and the actuator spaced apart from each other by a predetermined distance to be moved in a body, and compressed in response to increase of the pressure difference when the pressure difference is equal to or greater than the predetermined value, so that when the pressure difference is equal to or greater than the predetermined value, the valve member is moved together with the elastic member in response to increase of the pressure difference, to block the communication between the wheel brake cylinder and the reservoir, and to allow the hydraulic pressure supplied from the pressure generator to the wheel brake cylinder through the valve member.

Or, the hydraulic brake apparatus may be provided with a pressure source for generating hydraulic pressure, a pressure regulator valve for regulating the hydraulic pressure generated by the pressure source in response to operation of a manually operated braking member, a wheel brake cylinder operatively mounted on a wheel of the vehicle for applying braking force to the wheel with the hydraulic pressure fed from the pressure regulator valve, a reservoir for storing brake fluid, and a pressure regulating device which is disposed between the pressure regulator valve and the wheel brake cylinder, and connected with the reservoir, wherein the pressure regulating device regulates the hydraulic pressure fed into the wheel brake cylinder to provide a desired pressure less than the hydraulic pressure generated by the pressure regulator valve. And, the pressure regulating device may include a linear proportioning solenoid valve for selectively communicating the wheel brake cylinder with one of the reservoir and the pressure regulator valve, to regulate a pressure difference between the hydraulic pressure output from the pressure regulator valve and the hydraulic pressure fed into the wheel brake cylinder, into a desired value in response to electromagnetic force exerted by the linear proportioning solenoid valve, and a pressure difference limiting device for blocking the communication between the wheel brake cylinder and the reservoir, and communicating the pressure regulator valve with the wheel brake cylinder, when the pressure difference between the hydraulic pressure output from the pressure regulator valve and the hydraulic pressure fed into the wheel brake cylinder is equal to or greater than a predetermined value.

In the hydraulic brake apparatus as described above, the linear proportioning solenoid valve preferably includes a valve member with opposite ends thereof applied with the hydraulic pressure output from the pressure regulator valve and the hydraulic pressure fed into the wheel brake cylinder, respectively, and an electromagnetic actuator for actuating the valve member. And, the pressure difference limiting device may be disposed between the valve member and the actuator, and provided with an elastic member for holding the valve member and the actuator spaced apart from each other by a predetermined distance to be moved in a body, and compressed in response to increase of the pressure difference when the pressure difference is equal to or greater than the predetermined value, so that when the pressure difference is equal to or greater than the predetermined value, the valve member is moved together with the elastic member in response to increase of the pressure difference, to block the communication between the wheel brake cylinder and the reservoir, and to allow the hydraulic pressure supplied from the pressure regulator valve to the wheel brake cylinder through the valve member.

Furthermore, the hydraulic brake apparatus may be provided with a pressure source for generating hydraulic pressure, a pressure regulator valve for regulating the hydraulic pressure generated by the pressure source in response to operation of a manually operated braking member, a master cylinder having a pressure chamber for receiving therein the hydraulic pressure fed from the pressure regulator valve, and a master piston actuated by the hydraulic pressure in the pressure chamber to discharge hydraulic braking pressure, a wheel brake cylinder operatively mounted on a wheel of the vehicle for applying braking force to the wheel with the hydraulic braking pressure fed from the master cylinder, a reservoir for storing brake fluid, and a pressure regulating device which is disposed between the pressure regulator valve and the pressure chamber, and connected with the reservoir, wherein the pressure regulating device regulates the hydraulic braking pressure fed into the pressure chamber to provide a desired pressure less than the hydraulic braking pressure generated by the pressure regulator valve. And, the pressure regulating device may include a linear proportioning solenoid valve for selectively communicating the pressure chamber with one of the reservoir and the pressure regulator valve, to regulate a pressure difference between the hydraulic pressure output from the pressure regulator valve and the hydraulic pressure fed into the pressure chamber, into a desired value in response to electromagnetic force exerted by the linear proportioning solenoid valve, and a pressure difference limiting device for blocking the communication between the pressure chamber and the reservoir, and communicating the pressure regulator valve with the pressure chamber, when the pressure difference between the hydraulic pressure output from the pressure regulator valve and the hydraulic pressure fed into the pressure chamber is equal to or greater than a predetermined value.

In the hydraulic brake apparatus as described above, the linear proportioning solenoid valve preferably includes a valve member with opposite ends thereof applied with the hydraulic pressure output from the pressure regulator valve and the hydraulic pressure fed into the pressure chamber, respectively, and an electromagnetic actuator for actuating the valve member. And, the pressure difference limiting device may be disposed between the valve member and the actuator, and provided with an elastic member for holding the valve member and the actuator spaced apart from each other by a predetermined distance to be moved in a body, and compressed in response to increase of the pressure difference when the pressure difference is equal to or greater than the predetermined value, so that when the pressure difference is equal to or greater than the predetermined value, the valve member is moved together with the elastic member in response to increase of the pressure difference, to block the communication between the pressure chamber and the reservoir, and to allow the hydraulic pressure supplied from the pressure regulator valve to the pressure chamber through the valve member.

In each of the hydraulic brake apparatuses as described above, the reservoir includes a reservoir under atmospheric pressure which is connected to the pressure generator or pressure source, and a pressure decreasing reservoir disposed separately for use in the hydraulic pressure control, without limiting its type, structure, use or the like.

### BRIEF DESCRIPTION OF THE DRAWINGS

The above stated objects and following description will become readily apparent with reference to the accompanying drawings, wherein like reference numerals denote like elements, and in which:

FIG. 1 is a sectional view of a hydraulic brake apparatus according to an embodiment of the present invention;

FIG. 2 is an enlarged sectional view of a pressure regulating device for use in an embodiment of the present invention;

FIG. 3 is a sectional view of a hydraulic brake apparatus according to another embodiment of the present invention;

FIG. 4 is a sectional view of a hydraulic brake apparatus according to a further embodiment of the present invention; and

FIG. 5 is a sectional view of a hydraulic brake apparatus according to a yet further embodiment of the present invention.

### DESCRIPTION OF THE PREFERRED EMBODIMENTS

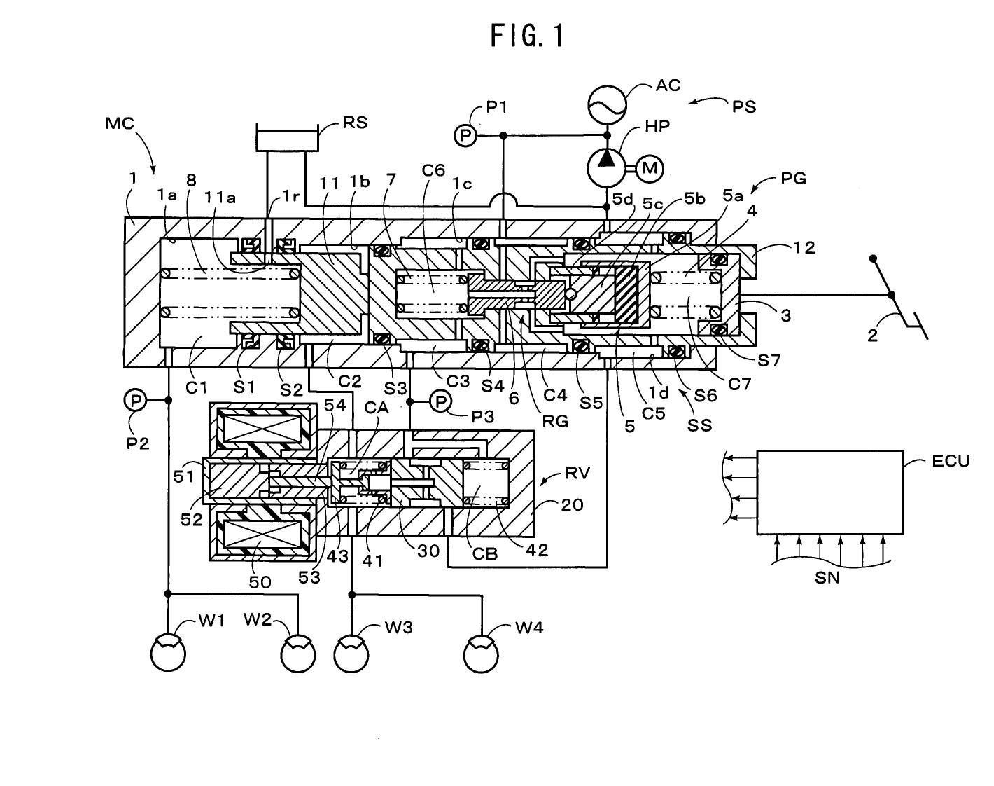

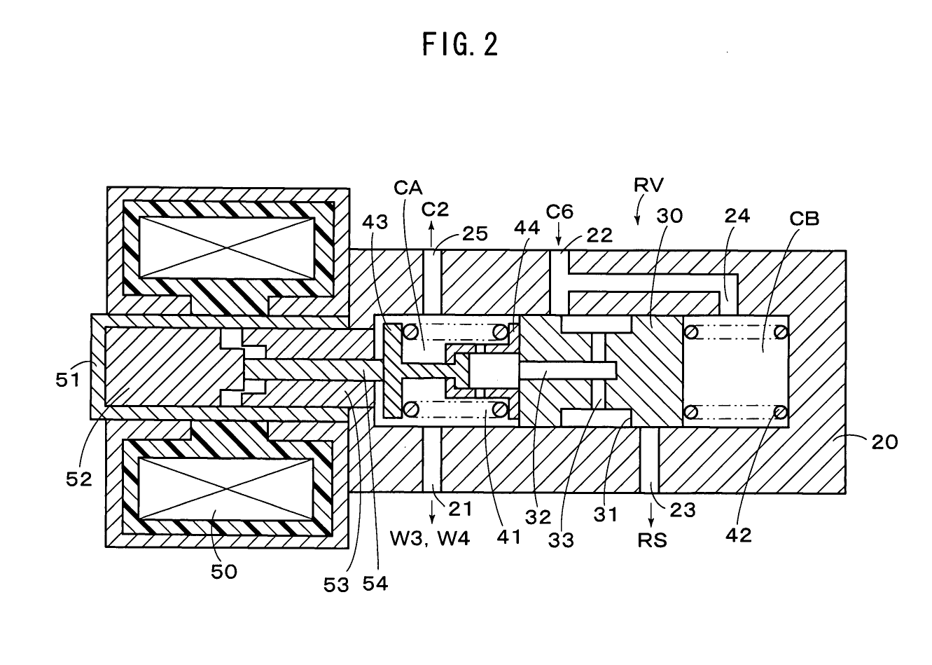

Referring to FIG. 1, there is illustrated a hydraulic brake apparatus for a vehicle according to an embodiment of the present invention, including a pressure regulating device RV as shown in FIG. 2, which serves as the pressure regulating means according to the present invention. At the outset, as shown in FIG. 1, the hydraulic brake apparatus includes a pressure generator PG, which serves as the pressure generating means according to the present invention, and which generates hydraulic pressure in response to operation of a brake pedal 2 which serves as the manually operated braking member. The apparatus includes wheel brake cylinders W1-W4, each of which is operatively mounted on each wheel of the vehicle, to apply braking force to the wheel with the hydraulic pressure fed from the pressure generator PG. Between the pressure generator PG and the wheel brake cylinders W1-W4, there is disposed the pressure regulating device RV which regulates the hydraulic pressure fed into the wheel brake cylinders W1-W4 to provide a desired pressure less than the hydraulic pressure generated by the pressure generator PG, and provides a pressure difference limiting function, as will be described later in detail.

According to the present embodiment, the pressure generator PG is provided with a pressure source PS for generating a certain hydraulic pressure irrespective of operation of the brake pedal 2. The pressure source PS includes an electric motor M controlled by an electronic control unit ECU, and a hydraulic pressure pump HP, which is driven by the electric motor M, and whose inlet is connected to a reservoir (under atmospheric pressure) RS, and whose outlet is connected to an accumulator AC. According to the present embodiment, a pressure sensor P1 is connected to the outlet, and the detected pressure is monitored by the electronic control unit ECU. On the basis of the monitored result, the motor M is controlled by the electronic control unit ECU to keep the hydraulic pressure in the accumulator AC between predetermined upper and lower limits.

In a cylinder 1 which serves as a body portion of the pressure generator PG, there is formed a stepped bore which includes bores 1a, 1b, 1c and 1d having different inner diameters from one another, and in which a master piston 11 and an auxiliary piston 12 are received. In the auxiliary piston 12, there are accommodated a regulator valve RG and a stroke simulator SS, which will be described later. Although the cylinder 1 is illustrated as one body in FIG. 1 to be understood easily, it is formed with a plurality of cylindrical members assembled together in practice. In the inner surface of the bore 1a of cylinder 1, there are disposed annular cup-like seal members S1 and S2, into which the master cylinder 11 in the shape of a cylinder with a bottom is fluid-tightly and slidably fitted. The auxiliary piston 12 has a plurality of land portions, which are formed around its outer surface, and on which a plurality of seal members S3-S6 are disposed, respectively. And, the auxiliary piston 12 is fitted into the bore 1b through the seal member S3, and in a bore 1c with a larger diameter than that of the bore 1b through the seal members S4 and S5, and in a bore id with a yet larger diameter than that of the bore 1c through the seal member S6, respectively. Thus, the auxiliary piston 12 is accommodated in the stepped cylinder bore as described above, and normally biased rearward because of the pressure relationship as explained later, to be held in its initial position as shown in FIG. 1. Then, if the pressure source PS is failed to discharge the hydraulic pressure, the auxiliary piston 12 is released from being held rearward, so that it comes to be in a state capable of being moved forward.

As shown in FIG. 1, a master chamber C1 is defined in the bore 1a of the cylinder 1 between the master piston 11 at the seal member S1 and the front end of the cylinder 1, and a pressure chamber C2 is defined in the bore 1b between the master piston 11 at the seal member S2 and the auxiliary piston 12 at the seal member S3. In FIG. 1, the front of the cylinder 1 is directed to the left. Thus, the master cylinder MC is formed in the front section of the cylinder 1. Furthermore, between the inner surfaces of the bores 1b, 1c and 1d of the cylinder 1 and the outer surface of the auxiliary piston 12, an annular chamber C3 is defined between the seal member S3 and the seal member S4, an annular chamber C4 is defined between the seal member S4 and the seal member S5, and an annular chamber C5 is defined between the seal member S5 and the seal member S6, respectively.

In the auxiliary piston 12, there is accommodated a spool valve mechanism which serves as the pressure regulator valve RG according to the present embodiment. In front of a spool 6, a regulator chamber C6 is defined to communicate with the annular chamber C3, and a low pressure chamber C7 is defined at the rear of the spool 6 to communicate with the annular chamber C5. An input piston 3 is fluid-tightly and slidably fitted into the auxiliary piston 12, so that the low pressure chamber C7 is defined in front of the input piston 3. Within the low pressure chamber C7, there are accommodated a distribution device 5 and a compression spring 4 for transmitting the braking operation force applied to the input piston 3 and providing a stroke for the input piston 3 in response to the braking operation force, to form the stroke simulator SS. Instead of the compression spring 4, any elastic member such as a rubber, air spring or the like may be employed.

The distribution device 5 is provided for adjusting the relationship between the braking operation force applied to the brake pedal 2 and the hydraulic pressure discharged from the pressure regulator valve RG. It includes a cylindrical member 5d with its front end abutting on the front end face of the auxiliary piston 12 in the low pressure chamber C7, and with its rear end mounting a plastic ring member thereon, a case 5a formed in the shape of a cylinder with a bottom, for slidably receiving therein the cylindrical member 5d, a rubber disc 5b disposed between the case 5a and the cylindrical member 5d, and a transmitting member 5c with a steel ball mounted on its front end. According to the distribution device 5, when the brake pedal 2 is depressed, the braking force is transmitted to the spool 6 through the input piston 3, compression spring 4, case 5a, rubber disc 5b and transmitting member 5c, so that the pressure regulator valve RG is operated to output the hydraulic pressure exerted in the regulator chamber C6, from the annular chamber C3. When the braking operation force exceeds a predetermined value, the elastically deformed rubber disc 5b abuts on the plastic ring member mounted on the cylindrical member 5d, so that a part of the braking operation force is distributed to be transmitted to the auxiliary piston 12 through the rubber disk 5b. According to the present embodiment, therefore, can be given a jumping property which provides a steep rise of pressure in the beginning of the braking operation. Also, with the inner diameter of the cylindrical member 5d and the outer diameter of the transmitting member 5c varied, a distribution ratio of the braking operation to be transmitted can be varied. Furthermore, with the length of the transmitting member 5c varied, a starting time for the distribution of the braking operation can be varied. Therefore, by combining the cylindrical member 5d and transmitting member 5c of different dimensions appropriately, the output property of the pressure regulator valve RG in response to the braking operation force can be provided as required. The distribution device 5 may be omitted, instead, it may be so constituted as to transmit the braking operation force directly to the spool 6.

As for the pressure regulator valve RG of the present embodiment, the compression spring 7 which acts as a return spring is accommodated in the regulator chamber C6 to press the spool 6 rearward by its biasing force. The mounting load of the compression spring 7 is set to be larger than the mounting load of the compression spring 4, so that when the brake pedal 2 is not depressed, the state as shown in FIG. 1 is maintained. The low pressure chamber C7 is connected to the reservoir RS together with the inlet of the pressure source PS, through the annular chamber C5, so that the annular chamber C5 and low pressure chamber C7 are filled with the brake fluid under approximately atmospheric pressure in the reservoir RS. The annular chamber C4 is connected to the accumulator AC of the pressure source PS, so that the hydraulic pressure discharged from the pressure source PS is supplied, to provide a relatively high pressure chamber.

Accordingly, when the spool 6 is placed at the rearmost initial position as shown in FIG. 1, the regulator chamber C6 is communicated with the low pressure chamber C7 through the spool 6 to be under the atmospheric pressure as in the reservoir RS. When the input piston 3 is moved forward, and then the spool 6 is moved forward to block the communication between the regulator chamber C6 and the low pressure chamber C7, the pressure in the regulator chamber C6 will be held. When the spool 6 is moved forward further, the regulator chamber C6 is communicated with the pressure source PS through the spool 6, auxiliary piston 12 and annular chamber C4, so that the hydraulic pressure discharged from the pressure source PS is fed into the regulator chamber C6 to increase the hydraulic pressure therein, thereby to provide a pressure increasing state. Thus, in accordance with a repetition of relative movement of the spool 6 to the auxiliary piston 12, the hydraulic pressure in the regulator chamber C6 is regulated into a predetermined pressure, and discharged to the pressure regulating device RV through the annular chamber C3, as will be described later.

In the master chamber C1, there is accommodated a compression spring 8 which acts as a return spring, and which forces the rear end surface of the master piston 11 to abut on the front end surface of the auxiliary piston 12. In other words, when the master piston 11 is placed at its initial position, i.e., the rearmost position, a communication hole 11a defined on a skirt portion of the master piston 11 is communicated with a communication hole 1r defined on a cylinder 1, so that the master chamber C1 is under approximately atmospheric pressure as in the reservoir RS. When the master piston 11 is moved forward, the communication hole 1r will be closed by its skirt portion, to block the communication with the reservoir RS. Therefore, when the hydraulic pressure discharged from the regulator chamber C6 is fed into the pressure chamber C2, the master piston 11 will be moved forward to supply the hydraulic braking pressure from the master chamber C1 to the wheel brake cylinders W1 and W2.

As shown in FIG. 1, according to the present embodiment, the wheel brake cylinders W1 and W2 operatively mounted on the front wheels are connected to the master chamber C1, to supply the hydraulic braking pressure from the master chamber C1 to them. On the contrary, the wheel brake cylinders W3 and W4 operatively mounted on the rear wheels are connected to the pressure chamber C2 (through the pressure regulating device RV), and also connected to the pressure generator PG (and reservoir RS) through the pressure regulating device RV, so that the hydraulic pressure in the pressure chamber C2 is supplied to the wheel brake cylinders W3 and W4, and regulated by the pressure regulating device RV. According to the present embodiment, a pressure sensor P2 is disposed in a pressure passage of the master chamber C1 at the output side thereof, and a pressure sensor P3 is disposed in a pressure passage of the annular chamber C3 (regulator chamber C6) at the output side thereof, and signals detected by the sensors P2 and P3 are fed to the electronic control unit ECU. Thus, the hydraulic pressure output from the pressure generator PG is monitored and provided for a regenerative braking cooperative control as will be described later. Furthermore, if pressure control valves such as eight electromagnetic switching valves for supplying and draining the hydraulic pressure (not shown) are disposed in the pressure passages connected to the wheel brake cylinders W1-W4, they may be provided for an anti-lock braking control. In order to achieve the anti-lock braking control or the like, sensors (indicated by “SN” in FIG. 1) such as wheel speed sensors are required, so that the signals detected by the sensors are fed into the electronic control unit ECU.

Although the pressure chamber C2 is connected to the wheel brake cylinders W3 and W4 through the pressure regulating device RV as illustrated in FIG. 1, the pressure chamber C2 is always communicated with the wheel brake cylinders W3 and W4 in fact (thorough the pressure regulating device RV), so that they are substantially directly connected with each other. Therefore, another passage for directly connecting the pressure chamber C2 to the wheel brake cylinders W3 and W4 may be provided, separately. Although the pressure regulating device RV is connected to the reservoir RS through the annular chamber C5 and low pressure chamber C7 as illustrated in FIG. 1, it may be directly connected to the reservoir RS. Or, a pressure reducing reservoir (not shown) may be provided separately, and connected to the pressure regulating device RV.

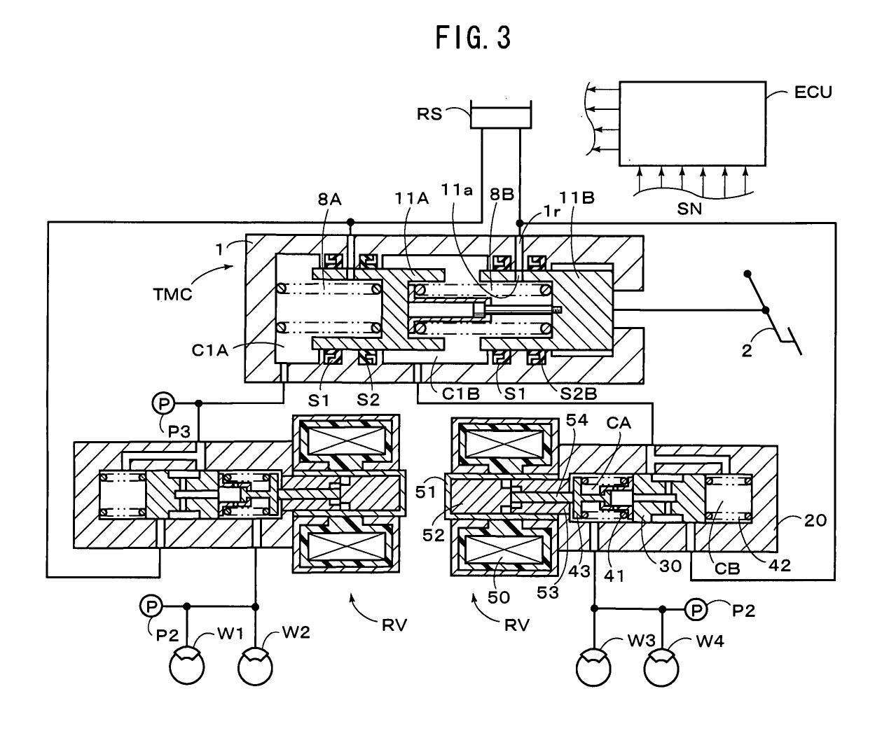

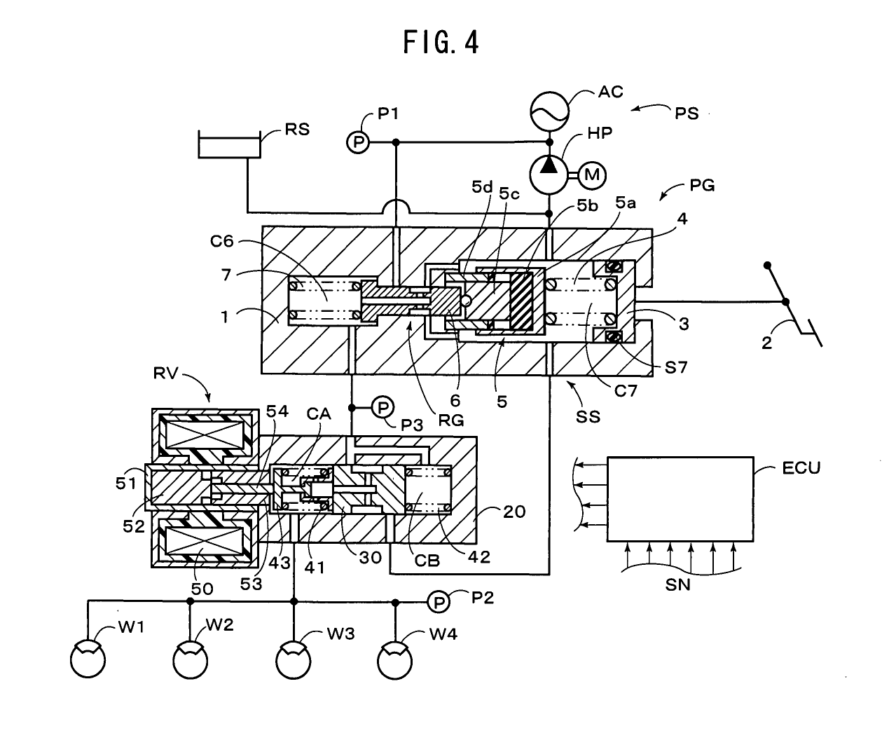

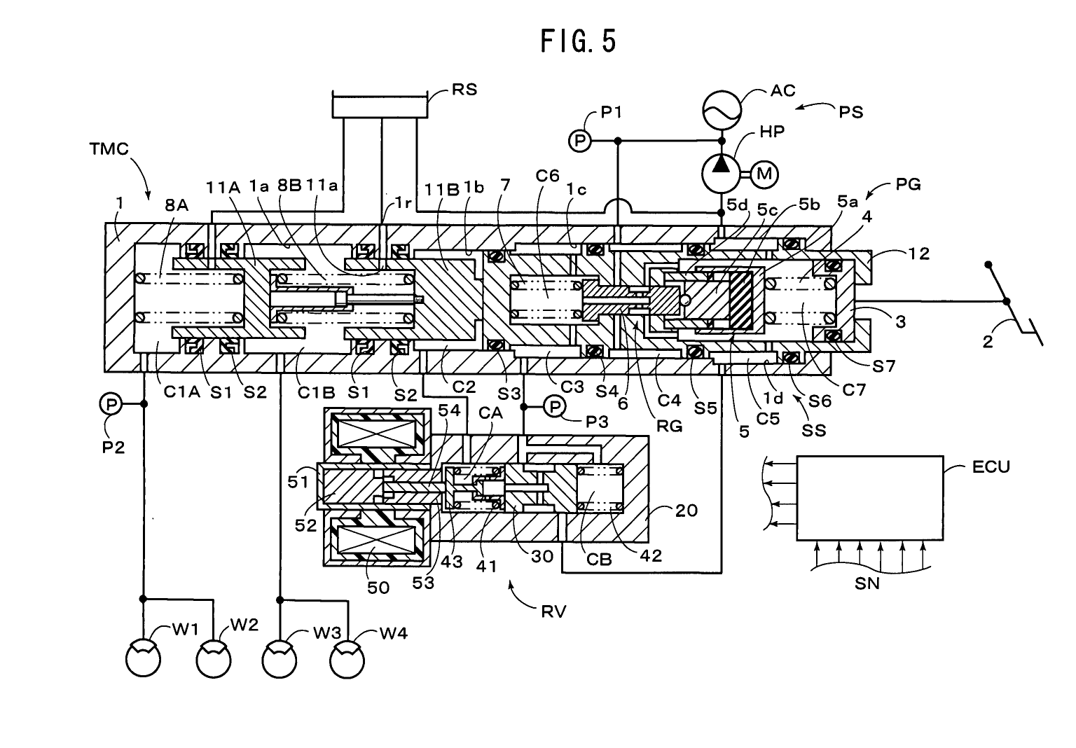

According to the hydraulic system as shown in FIG. 1, therefore, the following embodiments can be derived. As for the pressure generator PG, there may be several embodiments such as an embodiment with only a master cylinder (tandem master cylinder TMC) as a general embodiment as shown in FIG. 3, another embodiment provided with the pressure source PS and pressure regulator valve RG as shown in FIG. 4, and a further embodiment provided with all of the master cylinder MC, the pressure source PS and pressure regulator valve RG as shown in FIG. 1. Furthermore, another master cylinder may be added to the last embodiment to provide a yet further embodiment which constitutes a tandem master cylinder, as shown in FIG. 5. In any of those embodiments, the pressure regulating device RV functions effectively, as will be described hereinafter. In FIGS. 3-5, the same reference numerals denote the same elements as shown and explained in FIG. 1. In FIGS. 3 and 5, some elements have been added to constitute a tandem master cylinder TMC, such as the master pistons 11A and 11B, springs 8A and 8B, chambers C1A and C1B, and seal member S2B, with A or B added to the reference numerals of the elements having substantially the same function with the elements in FIG. 1, respectively.

With respect to the embodiment which is provided with only the master cylinder MC (tandem master cylinder TMC) as the pressure generator for generating hydraulic pressure in response to operation of the manually operated braking member as shown in FIG. 3, the hydraulic brake apparatus is provided with a couple of pressure regulating devices RV, RV disposed between the tandem master cylinder TMC and the wheel brake cylinders W1-W4 for regulating the hydraulic pressure fed into the wheel brake cylinders W1-W4 to provide a desired pressure less than the hydraulic pressure generated by the tandem master cylinder TMC, respectively. In this embodiment, each pressure regulating device RV is constituted by a linear proportioning solenoid valve for selectively communicating the wheel brake cylinders W1 and W2 (W3 and W4) with one of the reservoir RS and the tandem master cylinder TMC, to regulate a pressure difference between the hydraulic pressure output from the tandem master cylinder TMC and the hydraulic pressure fed into the wheel brake cylinders W1 and W2 (W3 and W4), into a desired value in response to electromagnetic force exerted by the solenoid valve, and so constituted that a pressure difference limiting device (compression spring 41 as described later) blocks the communication between the wheel brake cylinders W1 and W2 (W3 and W4) and the reservoir RS, and communicates the tandem master cylinder TMC with the wheel brake cylinders W1 and W2 (W3 and W4), when the pressure difference between the hydraulic pressure output from the tandem master cylinder TMC and the hydraulic pressure fed into the wheel brake cylinders W1 and W2 (W3 and W4) is equal to or greater than a predetermined value.

With respect to the embodiment which is provided with the pressure source PS as shown in FIG. 4 as the pressure source for generating hydraulic pressure, and the pressure regulator valve RG as to the pressure regulator valve for regulating the hydraulic pressure in response to operation of the manually operated braking member, and which is disposed between the pressure source PS and the wheel brake cylinders W1-W4 for regulating the hydraulic pressure fed into the wheel brake cylinders W1-W4 to provide a desired pressure less than the hydraulic pressure generated by the pressure regulator valve RG, respectively. In this embodiment, the pressure regulating device RV is constituted by a linear proportioning solenoid valve for selectively communicating the wheel brake cylinders W1-W4 with one of the reservoir RS and the pressure regulator valve RG, to regulate a pressure difference between the hydraulic pressure output from the pressure regulator valve RG and the hydraulic pressure fed into the wheel brake cylinders W1-W4, into a desired value in response to electromagnetic force exerted by the solenoid valve, and so constituted that a pressure difference limiting device (compression spring 41 as described later) blocks the communication between the wheel brake cylinders W1-W4 and the reservoir RS, and communicates the pressure regulator valve RG with the wheel brake cylinders W1-W4, when the pressure difference between the hydraulic pressure output from the pressure regulator valve RG and the hydraulic pressure fed into the wheel brake cylinders W1-W4 is equal to or greater than a predetermined value.

Then, with respect to the embodiment of the pressure generator as shown in FIG. 5, which is provided with the pressure source PS for generating hydraulic pressure, the pressure regulator valve RG as the pressure regulator valve for regulating the hydraulic pressure in response to operation of the manually operated braking member, and the tandem master cylinder TMC for supplying the discharged hydraulic pressure into the pressure chamber C2, and actuating the master pistons 11A and 11B by the hydraulic pressure in the pressure chamber C2 to discharge the hydraulic braking pressure, and which is provided with the pressure regulating device RV disposed between the pressure regulator valve RG and the pressure chamber C2 for regulating the hydraulic pressure fed into the pressure chamber C2 to provide a desired pressure less than the hydraulic pressure generated by the pressure regulator valve RG. In this embodiment, the pressure regulating device RV is constituted by a linear proportioning solenoid valve for selectively communicating the pressure chamber C2 with one of the reservoir RS and the pressure regulator valve RG, to regulate a pressure difference between the hydraulic pressure output from the pressure regulator valve RG and the hydraulic pressure fed into the pressure chamber C2, into a desired value in response to electromagnetic force exerted by the solenoid valve, and so constituted that a pressure difference limiting device (compression spring 41 as described later) blocks the communication between the pressure chamber C2 and the reservoir RS, and communicates the pressure regulator valve RG with the pressure chamber C2, when the pressure difference between the hydraulic pressure output from the pressure regulator valve RG and the hydraulic pressure fed into the pressure chamber C2 is equal to or greater than a predetermined value.

As enlarged in FIG. 2, the pressure regulating device RV comprises a proportioning electromagnetic valve with three ports (three-port linear solenoid valve). According to the embodiment as shown in FIG. 1 for example, the first port 21 defined in a cylinder 20 is connected to the wheel brake cylinders W3 and W4 as shown in FIG. 1, the second port 22 is connected to the regulator chamber C6 through the annular chamber C3 of the pressure generator PG as shown in FIG. 1, and the third port 23 is connected to the low pressure chamber C7 (and further to the reservoir RS) through the annular chamber CS of the pressure generator PG as shown in FIG. 1. Although a port 25 as indicated in FIG. 2 is connected to the pressure chamber C2, as shown in FIG. 1, the pressure chamber C2 may be connected to the wheel brake cylinders W3 and W4, at the downstream of the pressure generator PG without being connected thereto. In the cylinder 20, there is accommodated a spool 30 which serves as the valve member, and which is controlled proportionally by a solenoid coil 50 to change the connections among the three ports.

As shown in FIG. 2, the spool 30 is accommodated in the cylinder 20 to define hydraulic pressure chambers CA and CB at its opposite ends, respectively. Around the outer peripheral surface of the spool 30, an annular groove 31 is formed, and a hole 32 is defined in its axial direction to be opened at its front end, and communicated with an annular groove 31 through a radial passage 33. The front end face of the spool 30 opens to a hydraulic pressure chamber CA and its rear end face opens to a hydraulic pressure chamber CB. The spool 30 is adjusted to be placed at its initial position as shown in FIG. 2. The hydraulic pressure chamber CB is always communicated with the annular chamber C3 (and further to the regulator chamber C6) through a passage 24 and a port 22. The hydraulic pressure chamber CA is always communicated with the wheel brake cylinders W3 and W4 through a port 21, and always communicated with the pressure chamber C2 through a port 25. At the initial position as shown in FIG. 2, therefore, the annular groove 31 of the spool 30 faces the port 22, so that the hydraulic pressure chamber CA is communicated with the annular chamber C3 and the regulator chamber C6, thorough the hole 32, passage 33, annular groove 31 and port 22. Therefore, the hydraulic pressure discharged from the regulator chamber C6 is supplied to the pressure chamber C2 and the wheel brake cylinders W3 and W4. In this case, the third port 23 is closed by the outer peripheral surface of the spool 30.

In the hydraulic pressure chamber CA, there are accommodated a transmitting member 43 and a retainer 44, between which a compression spring 41 is disposed, so that a distance between the transmitting member 43 and the retainer 44 is set be maximal as shown in FIG. 2, when there is no pressure difference between the pressures in the hydraulic pressure chambers CA and CB. The biasing force of the compression spring 42 disposed in the hydraulic pressure chamber CB is set to be smaller than the biasing force of the compression spring 41. When the transmitting member 43 is pressurized rightward in FIG. 2, the spool 30 is moved rightward against the biasing force of the compression spring 42. On the contrary, when the pressure difference between the pressures in the hydraulic pressure chambers CA and CB is caused so that the pressure in the hydraulic pressure chamber CB becomes equal to or greater than the pressure in the hydraulic pressure chamber CA by the predetermined value, the spool 30 will be moved leftward against the biasing force of the compression spring 41. The compression spring 41 constitutes the elastic member of the present invention, and a rubber member or the like may be substituted for the compression spring 41.

On an end portion of the cylinder 20, a solenoid coil 50 is operatively mounted, with its movable core 52 and fixed core 53 accommodated in a case 51 which is formed in the shape of a cylinder with a bottom, and fitted into a hollow portion of the solenoid coil 50. The fixed core 53 is formed in a cylinder, and placed with its end face facing the hydraulic pressure chamber CA, and fixed to the case 51 and the cylinder 20. In the center of the fixed core 53, a plunger 54 is slidably received. The movable core 52 is placed movably along the same axis as the axis for the spool 30 and fixed core 53 (plunger 54), so that it is moved close to or away from the fixed core 53 in response to the electromagnetic force. Thus, the electromagnetic actuator of the present invention is constituted, wherein when the solenoid coil 50 is energized, the movable core 52 is moved toward the fixed core 53, so that the plunger 54 is moved rightward to move the spool 30 rightward. When the solenoid coil 50 is de-energized, the movable core 52 is moved leftward by the biasing force of the compression spring 42, apart from the fixed core 53 to return to the position as shown in FIG. 2.

As described before, when the spool 30 is placed at a position as shown in FIG. 2, the hydraulic pressure chamber CA is communicated with the regulator chamber C6, so that the pressure chamber C2 and the wheel brake cylinders W3 and W4 are to be increased in pressure, to provide a pressure increasing state. When the spool 30 is moved rightward in FIG. 2, and moved to a position where the annular groove 31 is not communicated with the ports 22 and 23, the communication between the hydraulic pressure chamber CA and the regulator chamber C6 is blocked, so that the hydraulic pressure in the hydraulic pressure chamber CA is held, to provide a pressure holding state. When the spool 30 is further moved rightward in FIG. 2, and moved to a position where the annular groove 31 faces the port 23 (with the port 22 closed), the hydraulic pressure chamber CA is communicated with the annular chamber CS and the low pressure chamber C7, through the hole 32, passage 33, annular groove 31 and port 23, so that the hydraulic pressure chamber CA is communicated with the reservoir RS, whereby the pressure chamber C2 and the wheel brake cylinders W3 and W4 are to be decreased, to provide a pressure decreasing state.

Accordingly, when the pressing force exerted in proportion to the exciting current to the solenoid coil 50 is transmitted to the spool 30 through the movable core 52, plunger 54, transmitting member 43 and compression spring 41, the spool 30 will be held at a position where the pressing force and the hydraulic pressure in the hydraulic pressure chamber CA will balance with the hydraulic pressure in the hydraulic pressure chamber CB. In this case, the compression spring 41 functions as if it is a rigid body, without its longitudinal length being changed. For example, if the hydraulic pressure in the hydraulic pressure chamber CA is reduced excessively, and consequently the force resulted from the pressure difference between the pressures in the hydraulic pressure chambers CA and CB becomes equal to or greater than the biasing force of the compression spring 41 (from which the biasing force of the compression spring 42 is to be subtracted in fact, but which is so small to be neglected), then the compression spring 41 will be compressed to move the spool 30 leftward, so that the hydraulic pressure output from the pressure regulator valve RG will be supplied from the regulator chamber C6 to the hydraulic pressure chamber CA to increase the hydraulic pressure in the wheel brake cylinders W3 and W4.

In operation, according to the pressure generator PG of the hydraulic brake apparatus of the embodiment as shown in FIGS. 1 and 2, when the brake pedal 2 is not depressed, the input piston 3 and the spool 6 of the pressure regulator valve RG are in the state as shown in FIG. 1. In this state, the spool 6 has been pressed onto the auxiliary piston 12 by the biasing force of the compression spring 7, so that the communication between the regulator chamber C6 and the annular chamber C4 is blocked, whereas the regulator chamber C6 is communicated with the low pressure chamber C7 (i.e., the pressure decreasing state). Consequently, the regulator chamber C6 has been communicated with the reservoir RS to be under the atmospheric pressure, the hydraulic pressure output from the regulator chamber C6 is not supplied to the pressure chamber C2 (through the pressure regulating device RV), so that the master piston 11 is held in its initial position as shown in FIG. 1.

When depressing force is applied to the brake pedal 2, the braking operation force is transmitted to the spool 6 through the input piston 3, compression spring 4 and distribution device 5, to advance the spool 6, with the compression spring 7 being compressed. In this occasion, the compression spring 4 is compressed to function as a stroke simulator. When the brake pedal 2 is depressed further against the biasing force of the compression spring 7, and the spool 6 is placed at a position where the regulator chamber C6 does not communicate with the annular chamber C4, nor the low pressure chamber C7, the pressure holding state is provided. When further depressing force is applied to the brake pedal 2 to advance the spool 6, the regulator chamber C6 will communicate with the annular chamber C4, with the communication between the regulator chamber C6 and the low pressure chamber C7 being blocked, so that the regulator chamber C6 will communicate with the annular chamber C4, to supply the hydraulic pressure output from the pressure source PS to the regulator chamber C6 through the annular chamber C4. As a result, the pressure increasing state is provided.

Therefore, if the brake pedal 2 is operated in the pressure decreasing state as shown in FIG. 1, the hydraulic pressure in the regulator chamber C6 is regulated by the pressure regulator valve RG into the hydraulic pressure determined in response to the force transmitted from the input piston 3 to the spool 6 through the compression spring 4 and distribution device 5, then the regulated pressure is supplied to the pressure chamber C2 (through the pressure regulating device RV), and supplied to the wheel brake cylinders W3 and W4 (through the pressure regulating device RV), and at the same time the master piston 11 is actuated by the regulated pressure. Consequently, the hydraulic pressure determined in response to the braking operation force is supplied from the master chamber C1 to the wheel brake cylinders W3 and W4, and the compression spring 4 of the stroke simulator SS is compressed, to provide a stroke determined in response to the braking operation force, and given to the input piston 3 and finally to the brake pedal 2.

With respect the pressure regulating device RV, the exciting current fed to the solenoid coil 50 is controlled by the electronic control unit ECU, thereby to control the operation of the spool 30, so that one of the pressure holding state and pressure decreasing state, in addition to the pressure increasing state as shown in FIG. 1, is selectively placed appropriately, whereby the hydraulic pressure in the wheel brake cylinders W3 and W4 is regulated into the desired pressure. Accordingly, the hydraulic pressure apparatus having the pressure regulating device RV may be applied for various uses.

For example, it may be used for a hydraulic pressure apparatus for performing a regenerative braking cooperative control as follows. When the regenerative braking control is performed in a vehicle driven by an electric motor, a priority is given to the regenerative braking control. The braking force obtained through the hydraulic pressure control must be reduced by an amount corresponding to the braking force obtained through the regenerative braking control. In this case, the pressure regulating device RV is controlled by the electronic control unit ECU to provide the pressure difference between the hydraulic pressure which is discharged from the master chamber C1, and which is detected by the pressure sensor P2, and the hydraulic pressure which is discharged from the annular chamber C3 (regulator chamber C6), and which is detected by the pressure sensor P3, so as to equalize the pressure difference with the pressure corresponding to the calculated regenerative braking force. Consequently, the hydraulic pressure reduced by the amount corresponding to the braking force obtained through the regenerative braking control will be supplied to the wheel brake cylinders W3 and W4. At the same time, the hydraulic pressure in the pressure chamber C2 is reduced as well, so that the hydraulic pressure discharged from the master chamber C1 is also reduced. Consequently, the hydraulic pressure reduced by the amount corresponding to the braking force obtained through the regenerative braking control will be supplied to the wheel brake cylinders W1 and W2, as well. In this case, because the auxiliary piston 12 has been formed in a stepped shape as described before, even if the hydraulic pressure in the pressure chamber C2 was reduced, the auxiliary piston 12 could be held at the position as shown in FIG. 1, by the hydraulic pressure in the annular chamber C3.

Thus, the pressure regulating device RV is used for reducing the wheel cylinder pressure corresponding to the regenerative braking force. Even if the hydraulic pressure in the hydraulic pressure chamber CA (i.e., the hydraulic pressure in the wheel brake cylinders W3 and W4) was excessively reduced due to failure or error of the pressure regulating device RV for example, when the pressure difference between the pressures in the hydraulic pressure chambers CA and CB becomes equal to or greater than the predetermined value, the compression spring 41 will be compressed to move the spool 30 leftward, so that the pressure decreasing state will be shifted to the pressure increasing state, via the pressure holding state. As a result, the hydraulic pressure discharged from the regulator chamber C1 is supplied to the hydraulic pressure chamber CA, so that the hydraulic pressure in the wheel brake cylinders W3 and W4 will be increased immediately, to ensure a rapid braking operation. In the case where the pressure regulating device RV is used for the regenerative braking cooperative control as described above, the predetermined value may be set around a value corresponding to a maximal regenerative braking force.

If the pressure source PS is failed during the operation of the pressure generator PG, the hydraulic pressure is not discharged from the pressure source PS to the annular chamber C4. In this case, therefore, when the input piston 3 is advanced in response to operation of the brake pedal 2, the spool 6 is advanced against the biasing force of the compression spring 7, and the input piston 3 is advanced against the biasing force of the compression spring 4, so that the force applied to the brake pedal 2 is transmitted to the auxiliary piston 12 through the distribution device 5, and further transmitted to the master piston 11, whereby the hydraulic braking pressure is supplied from the master chamber C1 to the wheel brake cylinders W1 and W2.

It should be apparent to one skilled in the art that the above-described embodiments are merely illustrative of but a few of the many possible specific embodiments of the present invention. Numerous and various other arrangements can be readily devised by those skilled in the art without departing from the spirit and scope of the invention as defined in the following claims.

What is claimed is:

1. A hydraulic brake apparatus for a vehicle comprising:
pressure generating means for generating hydraulic pressure in response to operation of a manually operated braking member;
a wheel brake cylinder operatively mounted on a wheel of said vehicle for applying braking force to said wheel with the hydraulic pressure fed from said pressure generating means;
a reservoir for storing brake fluid; and
pressure regulating means disposed between said pressure generating means and said wheel brake cylinder, and connected with said reservoir, wherein said pressure regulating means regulates the hydraulic pressure fed into said wheel brake cylinder to provide a desired pressure less than the hydraulic pressure generated by said pressure generating means, and wherein said pressure regulating means including;
a linear proportioning solenoid valve for selectively communicating said wheel brake cylinder with one of said reservoir and said pressure generating means, to regulate a pressure difference between the hydraulic pressure output from said pressure generating means and the hydraulic pressure fed into said wheel brake cylinder, into a desired value in response to electromagnetic force exerted by said linear proportioning solenoid valve, and
pressure difference limiting means for blocking the communication between said wheel brake cylinder and said reservoir, and communicating said pressure generating means with said wheel brake cylinder, when the pressure difference between the hydraulic pressure output from said pressure generating means and the hydraulic pressure fed into said wheel brake cylinder is equal to or greater than a predetermined value.

2. A hydraulic brake apparatus as set forth in claim 1, wherein said linear proportioning solenoid valve comprises;
a valve member with opposite ends thereof applied with the hydraulic pressure output from said pressure generating means and the hydraulic pressure fed into said wheel brake cylinder, respectively, and
an electromagnetic actuator for actuating said valve member, and
wherein said pressure difference limiting means is disposed between said valve member and said actuator, and provided with an elastic member for holding said valve member and said actuator spaced apart from each other by a predetermined distance to be moved in a body, and compressed in response to increase of the pressure difference when the pressure difference is equal to or greater than the predetermined value, so that when the pressure difference is equal to or greater than the predetermined value, said valve member is moved together with said elastic member in response to increase of the pressure difference, to block the communication between said wheel brake cylinder and said reservoir, and to allow the hydraulic pressure supplied from said pressure generating means to said wheel brake cylinder through said valve member.

3. A hydraulic brake apparatus for a vehicle comprising:
a pressure source for generating hydraulic pressure;
a pressure regulator valve for regulating the hydraulic pressure generated by said pressure source in response to operation of a manually operated braking member;
a wheel brake cylinder operatively mounted on a wheel of said vehicle for applying braking force to said wheel with the hydraulic pressure fed from said pressure regulator valve;
a reservoir for storing brake fluid; and
pressure regulating means disposed between said pressure regulator valve and said wheel brake cylinder, and connected with said reservoir, wherein said pressure regulating means regulates the hydraulic pressure fed into said wheel brake cylinder to provide a desired pressure less than the hydraulic pressure generated by said pressure regulator valve, and wherein said pressure regulating means including;
a linear proportioning solenoid valve for selectively communicating said wheel brake cylinder with one of said reservoir and said pressure regulator valve, to regulate a pressure difference between the hydraulic pressure output from said pressure regulator valve and the hydraulic pressure fed into said wheel brake cylinder, into a desired value in response to electromagnetic force exerted by said linear proportioning solenoid valve, and
pressure difference limiting means for blocking the communication between said wheel brake cylinder and said reservoir, and communicating said pressure regulator valve with said wheel brake cylinder, when the pressure difference between the hydraulic pressure output from said pressure regulator valve and the hydraulic pressure fed into said wheel brake cylinder is equal to or greater than a predetermined value.

4. A hydraulic brake apparatus as set forth in claim 3, wherein said linear proportioning solenoid valve comprises;
a valve member with opposite ends thereof applied with the hydraulic pressure output from said pressure regulator valve and the hydraulic pressure fed into said wheel brake cylinder, respectively, and
an electromagnetic actuator for actuating said valve member, and
wherein said pressure difference limiting means is disposed between said valve member and said actuator, and provided with an elastic member for holding said valve member and said actuator spaced apart from each other by a predetermined distance to be moved in a body, and compressed in response to increase of the pressure difference when the pressure difference is equal to or greater than the predetermined value, so that when the pressure difference is equal to or greater than the predetermined value, said valve member is moved together with said elastic member in response to increase of the pressure difference, to block the communication between said wheel brake cylinder and said reservoir, and to allow the hydraulic pressure supplied from said pressure regulator valve to said wheel brake cylinder through said valve member.

5. A hydraulic brake apparatus for a vehicle comprising:
a pressure source for generating hydraulic pressure;
a pressure regulator valve for regulating the hydraulic pressure generated by said pressure source in response to operation of a manually operated braking member;
a master cylinder having a pressure chamber for receiving therein the hydraulic pressure fed from said pressure regulator valve, and a master piston actuated by the hydraulic pressure in said pressure chamber to discharge hydraulic braking pressure;
a wheel brake cylinder operatively mounted on a wheel of said vehicle for applying braking force to said wheel with the hydraulic braking pressure fed from said master cylinder;
a reservoir for storing brake fluid; and
pressure regulating means disposed between said pressure regulator valve and said pressure chamber, and connected with said reservoir, wherein said pressure regulating means regulates the hydraulic braking pressure fed into said pressure chamber to provide a desired pressure less than the hydraulic braking pressure generated by said pressure regulator valve, and wherein said pressure regulating means including;
a linear proportioning solenoid valve for selectively communicating said pressure chamber with one of said reservoir and said pressure regulator valve, to regulate a pressure difference between the hydraulic pressure output from said pressure regulator valve and the hydraulic pressure fed into said pressure chamber, into a desired value in response to electromagnetic force exerted by said linear proportioning solenoid valve, and
pressure difference limiting means for blocking the communication between said pressure chamber and said reservoir, and communicating said pressure regulator valve with said pressure chamber, when the pressure difference between the hydraulic pressure output from said pressure regulator valve and the hydraulic pressure fed into said pressure chamber is equal to or greater than a predetermined value.

6. A hydraulic brake apparatus as set forth in claim 5, wherein said linear proportioning solenoid valve comprises;
a valve member with opposite ends thereof applied with the hydraulic pressure output from said pressure regulator valve and the hydraulic pressure fed into said pressure chamber, respectively, and
an electromagnetic actuator for actuating said valve member, and
wherein said pressure difference limiting means is disposed between said valve member and said actuator, and provided with an elastic member for holding said valve member and said actuator spaced apart from each other by a predetermined distance to be moved in a body, and compressed in response to increase of the pressure difference when the pressure difference is equal to or greater than the predetermined value, so that when the pressure difference is equal to or greater than the predetermined value, said valve member is moved together with said elastic member in response to increase of the pressure difference, to block the communication between said pressure chamber and said reservoir, and to allow the hydraulic pressure supplied from said pressure regulator valve to said pressure chamber through said valve member.

7. A hydraulic brake apparatus as set forth in claim 1, wherein said pressure generating means is a tandem master cylinder for generating hydraulic pressure in response to operation of said manually operated braking member to supply the hydraulic pressure to wheel brake cylinders operatively mounted on wheels of said vehicle through a couple of hydraulic circuits, respectively.

8. A hydraulic brake apparatus as set forth in claim 7, wherein said linear proportioning solenoid valve is disposed in each of said hydraulic circuits, and comprises;
a valve member with opposite ends thereof applied with the hydraulic pressure output from said tandem master cylinder and the hydraulic pressure fed into said wheel brake cylinders, respectively, and
an electromagnetic actuator for actuating said valve member, and
wherein said pressure difference limiting means is disposed between said valve member and said actuator, and provided with an elastic member for holding said valve member and said actuator spaced apart from each other by a predetermined distance to be moved in a body, and compressed in response to increase of the pressure difference when the pressure difference is equal to or greater than the predetermined value, so that when the pressure difference is equal to or greater than the predetermined value, said valve member is moved together with said elastic member in response to increase of the pressure difference, to block the communication between said wheel brake cylinders and said reservoir, and to allow the hydraulic pressure supplied from said tandem master cylinder to said wheel brake cylinders through said valve member.
